(19) United States
(12) Patent Application Publication
(10) Pub. No.: US 2023/0281649 A1
(43) Pub. Date: Sep. 7, 2023

(54) SYSTEM, METHOD, AND COMPUTER PROGRAM FOR INTELLIGENT VALUE STREAM MANAGEMENT

(71) Applicant: Amdocs Development Limited, Limassol (CY)

(72) Inventors: Limor Gueta, Mabuim (IL); Itsik David, Petach Tiqwa (IL); Shay Cohen, Singapore (SG)

(21) Appl. No.: 17/685,260

(22) Filed: Mar. 2, 2022

(51) Int. Cl. G06Q 30/02; G06N 20/00

(52) U.S. Cl. CPC G06Q 30/0203; G06N 20/00

(57) ABSTRACT

As described herein, a system, method, and computer program are provided for intelligent value stream management. In use, a questionnaire is generated for a plurality of customers of an organization, wherein the organization provides a platform running a plurality of services for use by the customers. The plurality of customers are provided with access to the questionnaire. Answers to the questionnaire are received from at least one customer of the plurality of customers. Data associated with actual usage of the plurality of services is collected. The answers received from the at least one customer and the collected data are processed, using a machine learning model, to predict at least one change to be made with respect to the plurality of services.

### FIELD OF THE INVENTION

The present invention relates to managing services provided to customers by an organization.

### BACKGROUND

Numerous organizations provide platforms on which various services run for use by customers. Thus, a customer can receive value from the organization via use of some or all of the services (also referred to as a value stream). In order to provide continuous quality for those services, an organization typically employs specific practices. For example, each domain within the organization may contain a set of specific practices and tools that perform critical DevOps functions in the value stream. These practices generally include hypothesis-driven development, behavior-driven design (BDD), test-driven development (TDD), A/B testing, and exploratory testing. Usually, automation is integrated in these practices to enhance the speed and accuracy (e.g. of testing) throughout the value stream.

In order to achieve an agile organization that will practice DevOps in an efficient way, a system is needed for validating all of the activities in the value stream. However, in a big and complex organization, it is not easy to identify the gaps throughout the value stream. There is thus a need for addressing these and/or other issues associated with the prior art.

### SUMMARY

As described herein, a system, method, and computer program are provided for intelligent value stream management. In use, a questionnaire is generated for a plurality of customers of an organization, wherein the organization provides a platform running a plurality of services for use by the customers. The plurality of customers are provided with access to the questionnaire. Answers to the questionnaire are received from at least one customer of the plurality of customers. Data associated with actual usage of the plurality of services is collected. The answers received from the at least one customer and the collected data are processed, using a machine learning model, to predict at least one change to be made with respect to the plurality of services.

### BRIEF DESCRIPTION OF THE DRAWINGS

FIG. 1 illustrates a method for intelligent value stream management, in accordance with one embodiment.

FIG. 2 illustrates a system flow diagram for intelligent value stream management, in accordance with one embodiment.

FIG. 3 illustrates a method for training a machine learning model to make predictions for intelligent value stream management, in accordance with one embodiment.

FIG. 4 illustrates a network architecture, in accordance with one possible embodiment.

FIG. 5 illustrates an exemplary system, in accordance with one embodiment.

### DETAILED DESCRIPTION

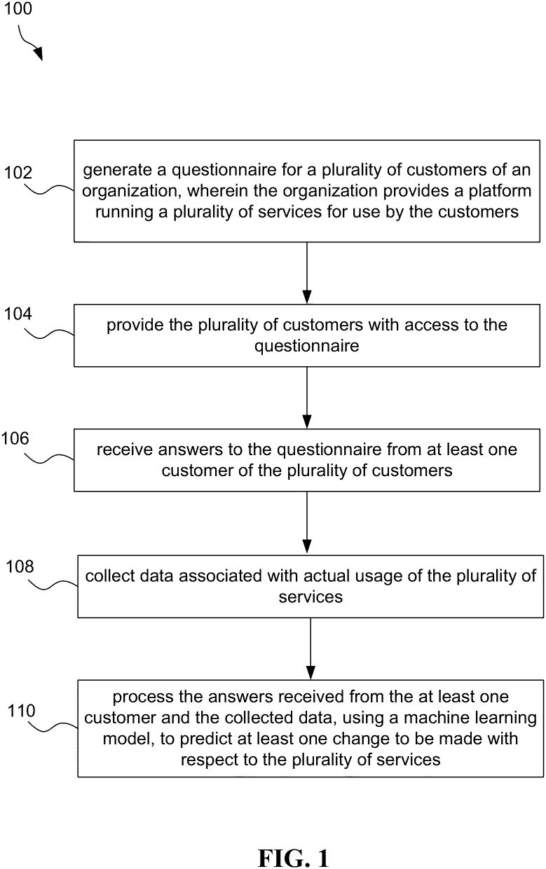

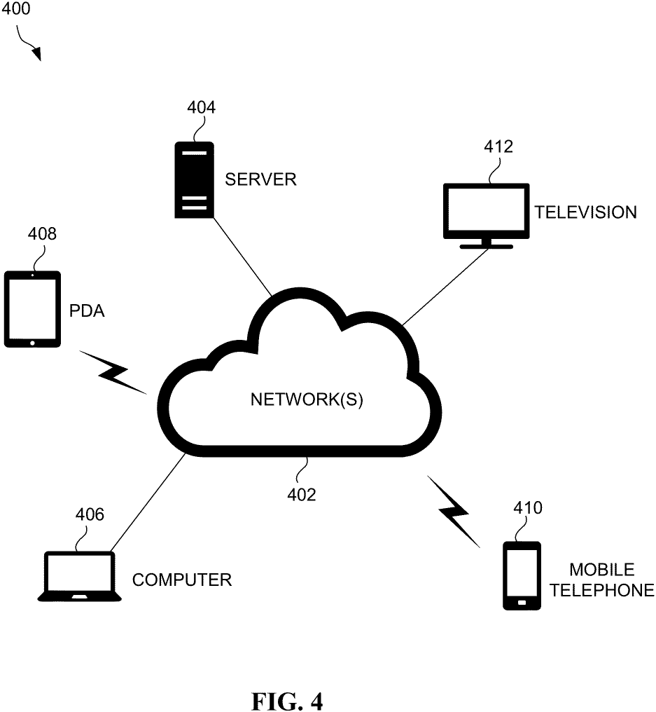

FIG. 1 illustrates a method 100 for intelligent value stream management, in accordance with one embodiment. The method 100 may be may be performed by any computer system described below with respect to FIGS. 4 and/or 5. For example, the method 100 may be performed by a computer system of an organization or a computer system of a third party interfacing the organization or a plurality of organizations. In the context of the present description, an organization refers to a business entity that provides a platform (e.g. computer hardware and/or software system) running a plurality of services (e.g. telecommunications services, etc.) for use by the customers. The customers may or may not be required to have an account with the organization in order to use the services.

In operation 102, a questionnaire is generated for a plurality of customers of an organization. The questionnaire refers to a plurality of questions capable of being answered by the customers. For example, the questionnaire may be a survey. In the present embodiment, the questionnaire refers to the organization and/or the services provided by the organization for use by the customers.

The questionnaire may be manually generated via a user interface, in an embodiment. In another embodiment, the questionnaire may be automatically generated based on features of the organization and/or the services. Of course, any such automatically generated questionnaire may be manually updated via user interface, as desired.

In operation 104, the plurality of customers are provided with access to the questionnaire. In one embodiment, the questionnaire may be located in the cloud (i.e. at a remote data center managed by the organization or a third party provider). For example, access to the questionnaire may be provided via a customer portal to the cloud.

In another embodiment, access to the questionnaire may be provided to each customer of the plurality of customers responsive to an authentication of the customer. The authentication may be performed using an account of the customer with the organization, in an embodiment. For example, the authentication man ensure that the user accessing the questionnaire is an existing (or newly subscribed) customer of the organization.

In operation 106, answers to the questionnaire are received from at least one customer of the plurality of customers. In particular, the answers to the questionnaire may be received via a user interface (e.g. of the above mentioned portal). The answers may be received as text, selections of predefined answer options, or in any other format supported by the questionnaire.

In operation 108, data associated with actual usage of the plurality of services is collected. In an embodiment, the actual usage refers, at least in part, to actual usage of the plurality of services by the plurality of customers. In another embodiment, the actual usage refers, at least in part, to actual usage of the plurality of services during testing of the plurality of services.

For example, the data associated with the actual usage of the plurality of services may include defects detected in association with the actual usage of the plurality of services. As another example, the data associated with the actual usage of the plurality of services may include automation scripts executed in association with the plurality of services. As yet another example, the data associated with the actual usage of the plurality of services may include test cases executed in association with the plurality of services. As another example, the data associated with the actual usage of the plurality of services may include user stories generated for the plurality of services.

It should be noted that the data may be collected from any systems or repositories storing such data, such as customer-specific repositories or systems, testing repositories or systems, etc.

In operation 110, the answers received from the at least one customer and the collected data are processed, using a machine learning model, to predict at least one change to be made with respect to the plurality of services. The change may refer to a removal of existing functionality associated with the plurality of services, an addition of new functionality in association with the plurality of services, a modification to existing functionality associated with the plurality of services, etc. Accordingly, the change may be made to the platform of the organization, in one embodiment.

As noted above, the change is predicted using a machine learning model. Thus, the machine learning model may be trained to predict changes to be made with respect to the plurality of services, based on actual usage of the services and based on input from the customers via the questionnaire. In an embodiment, the machine learning model may be trained to predict such changes for improving a value stream provided by the organization to the plurality of customers.

In an embodiment, the machine learning model is trained using training data. The training data may be generated by collecting historical data, and cleaning and normalizing the historical data using natural language processing to build a tokenized dictionary representing the training data. In one embodiment, the machine learning model may be a regression classification model.

As an option, an indication of the at least one change to be made with respect to the plurality of services may be output. For example, the indication of the change may be output to a user as a recommendation for making the change. As another option, the indication of the change may be output to a system capable of implementing the change within the platform of the organization. As noted above, the change may include an improvement to the plurality of services, and in this case the change may be implemented such that the improvement is made to the plurality of services.

As a further option, the machine learning model may also process the answers received from the at least one customer and the collected data to generate at least one score comparing the plurality of services to an industry benchmark. The generated scores may then be output (e.g. to the customer(s) and/or organization).

In this way, the method 100, as described above, may enable management (including monitoring, analyzing, reporting, etc.) of a value stream of the organization. In various implementations, the method 100 may be performed 1) to provide traceability for recommended features and technical components (TCs), 2) to recommend and identify the gaps throughout the value stream, 3) to predict weak areas in design, development and testing, 4) to recommend digital and non-functional testing in early stages, and/or 4) to recommend the blueprint for any testing environment and data according to the relevant feature.

More illustrative information will now be set forth regarding various optional architectures and uses in which the foregoing method may or may not be implemented, per the desires of the user. It should be strongly noted that the following information is set forth for illustrative purposes and should not be construed as limiting in any manner. Any of the following features may be optionally incorporated with or without the exclusion of other features described.

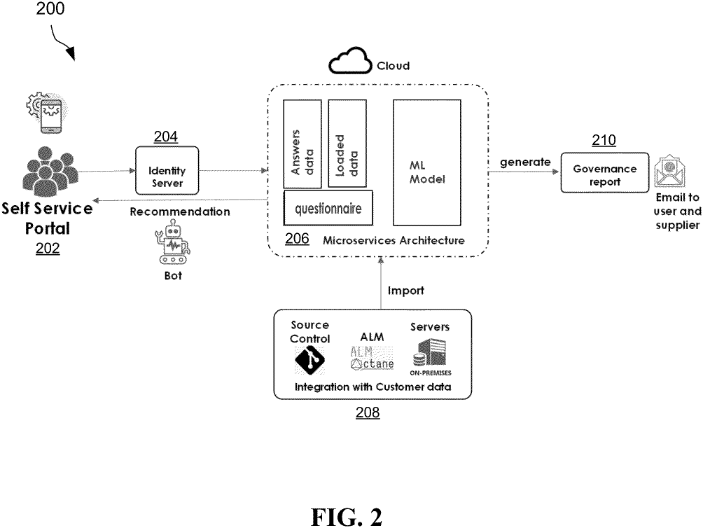

FIG. 2 illustrates a flow diagram of a system 200 for intelligent value stream management, in accordance with one embodiment. As an option, the system 200 may be implemented in the context of the details of the previous figure and/or any subsequent figure(s). Of course, however, the system 200 may be implemented in the context of any desired environment. Further, the aforementioned definitions may equally apply to the description below.

As shown, a microservices architecture is used to provide an intelligent value stream management sub-system 206 in the cloud. The intelligent value stream management sub-system 206 stores a questionnaire associated with services provided by an organization. Customers of the organization use a self service portal 202 to access the questionnaire. In the embodiment shown, an identity server 204 is used to authenticate the customers prior to allowing the customers to access the questionnaire.

The customers provide answers to the questionnaire, which is stored by the sub-system 206 as “answers data.” The sub-system 206 also collects data associated with actual usage of the services from external repositories and/or systems 208, and stores such data as “loaded data.” The sub-system 206 includes a machine learning model that is trained to make predictions for changes to be made to the servers, based on the “answers data” and the “loaded data.”

As shown, when the machine learning model makes a prediction based on the “answers data” and the “loaded data,” the prediction is output in a “governance report.” The “governance report” can indicate the change as a recommendation for the platform of the organization. In an additional embodiment, the machine learning model may make a prediction about scores related to the services as compared to predefined benchmarks. In this embodiment, the “governance report” can include the scores as well. The “governance report” can then be emailed or otherwise communicated to the customer and/or the organization.

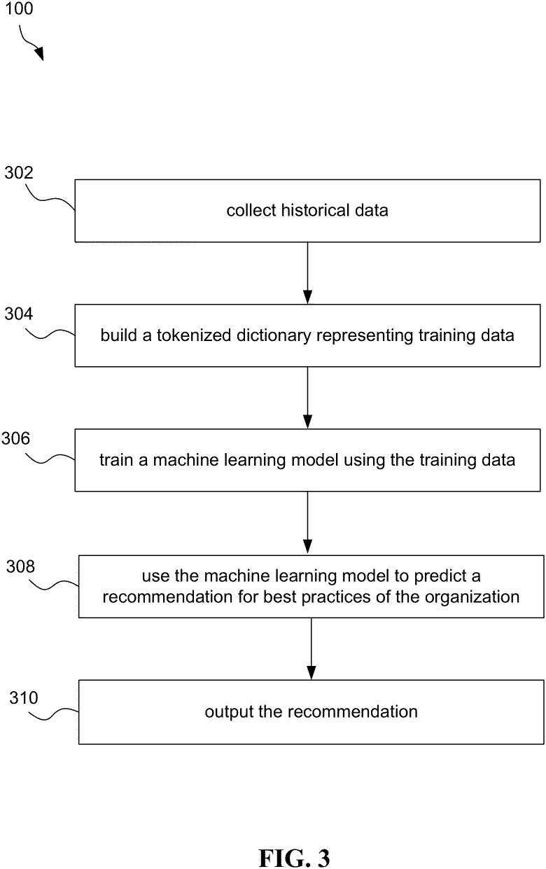

FIG. 3 illustrates a method 300 for training a machine learning model to make predictions for intelligent value stream management, in accordance with one embodiment. As an option, the method 300 may be carried out in the context of the details of the previous figure and/or any subsequent figure(s). Of course, however, the method 300 may be carried out in the context of any desired environment. Further, the aforementioned definitions may equally apply to the description below.

In operation 302, historical data is collected. The historical data includes information indicating historical usage of the services of the organization, such as actual customer usage and/or testing-related usage. The historical data may also include historical customer feedback (e.g. received via historical questionnaires). The historical data may further include past changes made with respect to the services (e.g. to improve the services).

In operation 304,a tokenized dictionary representing training data is built from the historical data. For example, the historical data may be cleaned and normalized using a natural language processing mechanism to build the tokenized dictionary.

In operation 306, a machine learning model is trained using the tokenized dictionary. In an embodiment, the model may be a regression classification model built on the historical data.

In operation 308, the machine learning model is used to predict a recommendation for best practices of the organization. In particular, customer input received via a questionnaire and data associated with actual usage of the services may be processed using the model. The model may predict a recommendation that influences the full Software Development Life Cycle process. For example, the recommendation may be for additional technologies and/or processes. Thus, efficiency of the organization may be improved according to the recommended journey given by the model.

In operation 310, the recommendation is output. For example, the recommendation may be output to the organization.

One exemplary implementation of the method 300 may relate to traceability of recommendations and total compensation. For example, this implementation could include, for operation 302, to load all features and TCs written in ALM/Excel into the machine as a training data. It will include Summary, Description, Priority, Exit Criteria and more. The implementation could include, for operation 304, to clean and normalize the features and TCs using a natural language processing mechanism to build the tokenized pattern for features and TCs relevant information. The implementation could include, for operation 306, to build a regression classification model on huge historical data. The model will need to synthesize between features and TCs relations (i.e. provide traceability). The implementation could include, for operation 308, to predict a recommendation for a right description of features and TCs, to indicate the coverage of a feature using specific TCs, ensure definition of done (DOD), and to recommend additional digital and non-functional testing. The efficiency may be improved according to the recommended journey given by the tool, i.e. full traceability, and focus on subscriber behavior to provide higher quality of the product.

FIG. 4 illustrates a network architecture 400, in accordance with one possible embodiment. As shown, at least one network 402 is provided. In the context of the present network architecture 400, the network 402 may take any form including, but not limited to a telecommunications network, a local area network (LAN), a wireless network, a wide area network (WAN) such as the Internet, peer-to-peer network, cable network, etc. While only one network is shown, it should be understood that two or more similar or different networks 402 may be provided.

Coupled to the network 402 is a plurality of devices. For example, a server computer 404 and an end user computer 406 may be coupled to the network 402 for communication purposes. Such end user computer 406 may include a desktop computer, lap-top computer, and/or any other type of logic. Still yet, various other devices may be coupled to the network 402 including a personal digital assistant (PDA) device 408, a mobile phone device 410, a television 412, etc.

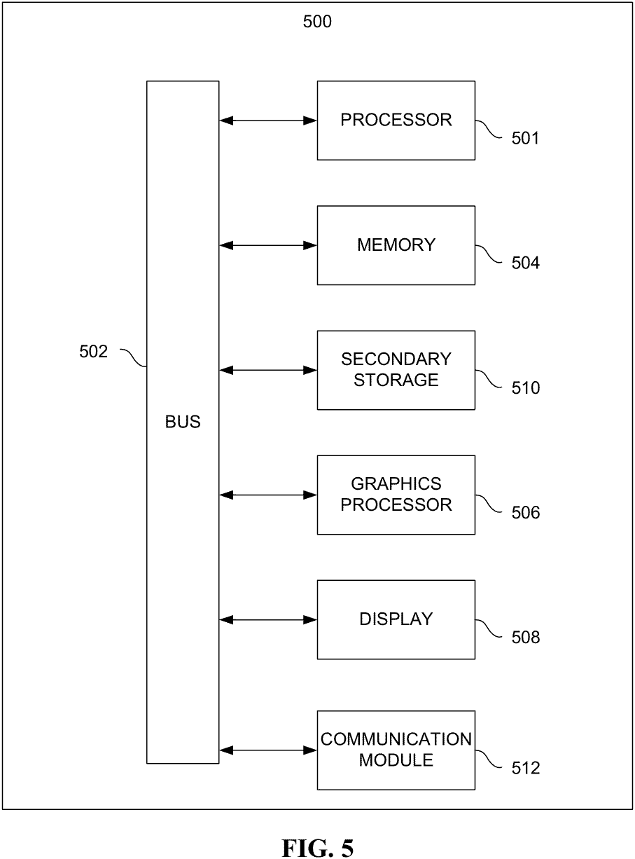

FIG. 5 illustrates an exemplary system 500, in accordance with one embodiment. As an option, the system 500 may be implemented in the context of any of the devices of the network architecture 400 of FIG. 4. Of course, the system 500 may be implemented in any desired environment.

As shown, a system 500 is provided including at least one central processor 501 which is connected to a communication bus 502. The system 500 also includes main memory 504 [e.g. random access memory (RAM), etc.]. The system 500 also includes a graphics processor 506 and a display 508.

The system 500 may also include a secondary storage 510. The secondary storage 510 includes, for example, solid state drive (SSD), flash memory, a removable storage drive, etc. The removable storage drive reads from and/or writes to a removable storage unit in a well-known manner.

Computer programs, or computer control logic algorithms, may be stored in the main memory 504, the secondary storage 510, and/or any other memory, for that matter. Such computer programs, when executed, enable the system 500 to perform various functions (as set forth above, for example). Memory 504, storage 510 and/or any other storage are possible examples of non-transitory computer-readable media.

The system 500 may also include one or more communication modules 512. The communication module 512 may be operable to facilitate communication between the system 500 and one or more networks, and/or with one or more devices through a variety of possible standard or proprietary communication protocols (e.g. via Bluetooth, Near Field Communication (NFC), Cellular communication, etc.).

As used here, a “computer-readable medium” includes one or more of any suitable media for storing the executable instructions of a computer program such that the instruction execution machine, system, apparatus, or device may read (or fetch) the instructions from the computer readable medium and execute the instructions for carrying out the described methods. Suitable storage formats include one or more of an electronic, magnetic, optical, and electromagnetic format. A non-exhaustive list of conventional exemplary computer readable medium includes: a portable computer diskette; a RAM; a ROM; an erasable programmable read only memory (EPROM or flash memory); optical storage devices, including a portable compact disc (CD), a portable digital video disc (DVD), a high definition DVD (HD-DVD™), a BLU-RAY disc; and the like.

It should be understood that the arrangement of components illustrated in the Figures described are exemplary and that other arrangements are possible. It should also be understood that the various system components (and means) defined by the claims, described below, and illustrated in the various block diagrams represent logical components in some systems configured according to the subject matter disclosed herein.

For example, one or more of these system components (and means) may be realized, in whole or in part, by at least some of the components illustrated in the arrangements illustrated in the described Figures. In addition, while at least one of these components are implemented at least partially as an electronic hardware component, and therefore constitutes a machine, the other components may be implemented in software that when included in an execution environment constitutes a machine, hardware, or a combination of software and hardware.

More particularly, at least one component defined by the claims is implemented at least partially as an electronic hardware component, such as an instruction execution machine (e.g., a processor-based or processor-containing machine) and/or as specialized circuits or circuitry (e.g., discreet logic gates interconnected to perform a specialized function). Other components may be implemented in software, hardware, or a combination of software and hardware. Moreover, some or all of these other components may be combined, some may be omitted altogether, and additional components may be added while still achieving the functionality described herein. Thus, the subject matter described herein may be embodied in many different variations, and all such variations are contemplated to be within the scope of what is claimed.

In the description above, the subject matter is described with reference to acts and symbolic representations of operations that are performed by one or more devices, unless indicated otherwise. As such, it will be understood that such acts and operations, which are at times referred to as being computer-executed, include the manipulation by the processor of data in a structured form. This manipulation transforms the data or maintains it at locations in the memory system of the computer, which reconfigures or otherwise alters the operation of the device in a manner well understood by those skilled in the art. The data is maintained at physical locations of the memory as data structures that have particular properties defined by the format of the data. However, while the subject matter is being described in the foregoing context, it is not meant to be limiting as those of skill in the art will appreciate that several of the acts and operations described hereinafter may also be implemented in hardware.

To facilitate an understanding of the subject matter described herein, many aspects are described in terms of sequences of actions. At least one of these aspects defined by the claims is performed by an electronic hardware component. For example, it will be recognized that the various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context.

The use of the terms “a” and “an” and “the” and similar referents in the context of describing the subject matter (particularly in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. Furthermore, the foregoing description is for the purpose of illustration only, and not for the purpose of limitation, as the scope of protection sought is defined by the claims as set forth hereinafter together with any equivalents thereof entitled to. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

The embodiments described herein included the one or more modes known to the inventor for carrying out the claimed subject matter. Of course, variations of those embodiments will become apparent to those of ordinary skill in the art upon reading the foregoing description. The inventor expects skilled artisans to employ such variations as appropriate, and the inventor intends for the claimed subject matter to be practiced otherwise than as specifically described herein. Accordingly, this claimed subject matter includes all modifications and equivalents of the subject matter recited in the claims appended hereto as permitted by applicable law. Moreover, any combination of the above-described elements in all possible variations thereof is encompassed unless otherwise indicated herein or otherwise clearly contradicted by context.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A non-transitory computer-readable media storing computer instructions which when executed by one or more processors of a device cause the device to:
generate a questionnaire for a plurality of customers of an organization, wherein the organization provides a platform running a plurality of services for use by the customers;
provide the plurality of customers with access to the questionnaire;
receive answers to the questionnaire from at least one customer of the plurality of customers;
collect data associated with actual usage of the plurality of services; and
process the answers received from the at least one customer and the collected data, using a machine learning model, to predict at least one change to be made with respect to the plurality of services.

2. The non-transitory computer-readable media of claim 1, wherein the questionnaire is manually generated via a user interface.

3. The non-transitory computer-readable media of claim 1, wherein the questionnaire is located in the cloud and wherein the access to the questionnaire is provided to each customer of the plurality of customers responsive to an authentication of the customer.

4. The non-transitory computer-readable media of claim 1, wherein the answers to the questionnaire are received via a user interface.

5. The non-transitory computer-readable media of claim 1, wherein the actual usage of the plurality of services includes, at least in part, actual usage of the plurality of services by the plurality of customers.

6. The non-transitory computer-readable media of claim 1, wherein the actual usage of the plurality of services includes, at least in part, actual usage of the plurality of services during testing of the plurality of services.

7. The non-transitory computer-readable media of claim 1, wherein the data associated with the actual usage of the plurality of services includes defects detected in association with the actual usage of the plurality of services.

8. The non-transitory computer-readable media of claim 1, wherein the data associated with the actual usage of the plurality of services includes automation scripts executed in association with the plurality of services.

9. The non-transitory computer-readable media of claim 1, wherein the data associated with the actual usage of the plurality of services includes test cases executed in association with the plurality of services.

10. The non-transitory computer-readable media of claim 1, wherein the data associated with the actual usage of the plurality of services includes user stories generated for the plurality of services.

11. The non-transitory computer-readable media of claim 1, wherein the machine learning model is trained to predict changes to be made with respect to the plurality of services for improving a value stream provided by the organization to the plurality of customers.

12. The non-transitory computer-readable media of claim 11, wherein the machine learning model is trained using training data.

13. The non-transitory computer-readable media of claim 12, wherein the training data is generated by:
collecting historical data, and
cleaning and normalizing the historical data using natural language processing to build a tokenized dictionary representing the training data.

14. The non-transitory computer-readable media of claim 12, wherein the machine learning model is a regression classification model.

15. The non-transitory computer-readable media of claim 1, further comprising:
outputting an indication of the at least one change to be made with respect to the plurality of services.

16. The non-transitory computer-readable media of claim 1, wherein the at least one change includes an improvement to the plurality of services.

17. The non-transitory computer-readable media of claim 16, further comprising:
making the improvement to the plurality of services.

18. The non-transitory computer-readable media of claim 1, wherein the machine learning model further processes the answers received from the at least one customer and the collected data to generate at least one score comparing the plurality of services to an industry benchmark, and further comprising:
outputting the at least one score to at least one of the at least one customer or the organization.

19. A method, comprising:
at a computer system:
generating a questionnaire for a plurality of customers of an organization, wherein the organization provides a platform running a plurality of services for use by the customers;
providing the plurality of customers with access to the questionnaire;
receiving answers to the questionnaire from at least one customer of the plurality of customers;
collecting data associated with actual usage of the plurality of services;
processing the answers received from the at least one customer and the collected data, using a machine learning model, to predict at least one change to be made with respect to the plurality of services.

20. A system, comprising:
a non-transitory memory storing instructions; and
one or more processors in communication with the non-transitory memory that execute the instructions to:
generate a questionnaire for a plurality of customers of an organization, wherein the organization provides a platform running a plurality of services for use by the customers;
provide the plurality of customers with access to the questionnaire;
receive answers to the questionnaire from at least one customer of the plurality of customers;
collect data associated with actual usage of the plurality of services; and
process the answers received from the at least one customer and the collected data, using a machine learning model, to predict at least one change to be made with respect to the plurality of services.
